(19) United States
(12) Patent Application Publication
(10) Pub. No.: US 2009/0034620 A1
(43) Pub. Date: Feb. 5, 2009

(54) MOTION ESTIMATION METHOD

(75) Inventors: Mayumi Okumura, Osaka (JP); Masaki Hamamoto, Hyogo (JP); Yuichiro Murachi, Hyogo (JP); Junichi Miyakoshi, Hyogo (JP); Masahiko Yoshimoto, Hyogo (JP); Tetsuro Matsuno, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: MegaChips Corporation, Osaka (JP); National University Corporation KOBE, Hyogo (JP)

(21) Appl. No.: 12/088,303

(22) PCT Filed: Jun. 29, 2006
(86) PCT No.: PCT/JP2006/312980

§ 371 Date: Mar. 27, 2008

(30) Foreign Application Priority Data
Sep. 29, 2005 (JP) 2005-284116

(51) Int. Cl. H04N 7/26

(52) U.S. Cl. 375/240.16; 375/E07.123

(57) ABSTRACT

A motion estimation method capable of reducing the amount of calculation as compared to a full search method. In the method, a coarse search block and fine search blocks are defined. The fine search blocks are given by dividing the coarse search block into a plurality of blocks so that the fine search blocks are contained in the coarse search block. A sparsely interpolated image and a densely interpolated image are defined. A first search is performed using the defined coarse search block and the defined sparsely interpolated image. A second search is performed using the defined coarse search block and the defined densely interpolated image. With regard to search blocks belonging to the fine search blocks, only a surrounding region of an optimal point obtained in the first search is searched.

### TECHNICAL FIELD

The present invention relates to a motion estimation method for realizing motion compensation by performing image processing.

### BACKGROUND ART

In H. 264 (also referred to as MPEG-4 Part 10, or AVC (advanced video coding)) as one of high efficiency coding systems, motion compensation is realized using seven search blocks of different block sizes and three interpolated images of different pixel accuracies.

According to a conventional full search method, search is performed using each of the search blocks of all types in the most densely interpolated image to obtain an optimal motion vector with regard to each search block.

Techniques relevant to the motion estimation using several kinds of search blocks of different block sizes are introduced for example in the following patent publications 1 to 5.

Patent Publication 1: Japanese Patent Application Laid-Open No. 2004-186897

Patent Publication 2: Japanese Patent Application Laid-Open No. 2004-48552

Patent Publication 3: United States Published Application No. 2004/0120440

Patent Publication 4: United States Published Application No. 2004/0190616

Patent Publication 5: United States Published Application No. 2004/0218675

### DISCLOSURE OF INVENTION

Problems to be Solved by the Invention

According to the conventional full search method, an optimal motion vector for each search block has higher adaptability. This however results in a problem that a considerably large amount of calculation is required for motion estimation.

The present invention has been made to solve the above-discussed problem. It is an object of the present invention to provide a motion estimation method capable of reducing the amount of calculation as compared to the full search method.

Means for Solving Problems

A motion estimation method of a first invention comprises: (a) in a macroblock targeted for motion estimation, a step of defining a coarse search block, and several fine search blocks that are given by dividing the coarse search block into a plurality of blocks so that the several fine search blocks are contained in the coarse search block; (b) in a first interpolated image, a step of performing search using the coarse search block to obtain an optimal point with the highest degree of similarity to the coarse search block in the macroblock; (c) in a second interpolated image denser than the first interpolated image, a step of performing search of a surrounding region of the optimal point using the coarse search block to obtain an optimal motion vector with regard to the coarse search block; and (d) in the second interpolated image, a step of performing search of the surrounding region of the optimal point using each one of the several fine search blocks to obtain respective optimal motion vectors with regard to the fine search blocks, the step (d) being carried out simultaneously with the step (c). The motion estimation method of the first invention is characterized in that, in the step (c), the degree of similarity with respect to the coarse search block at each point in the surrounding region of the optimal point is calculated as a total sum of respective degrees of similarity that are obtained in the step (d) with respect to the several fine search blocks.

A motion estimation method of a second invention is characterized in that, especially in the motion estimation method of the first invention, the coarse search block includes a first coarse search block, and a second coarse search block and a third coarse search block that are given by dividing the first coarse search block into a plurality of blocks so that the second and the third coarse search blocks are contained in the first coarse search block. The step (b) comprises: (b-1) in the first interpolated image, a step of performing search using the first coarse search block to obtain a first optimal point with the highest degree of similarity to the first coarse search block in the macroblock; (b-2) in the first interpolated image, a step of performing search using the second coarse search block to obtain a second optimal point with the highest degree of similarity to the second coarse search block in the macroblock; and (b-3) in the first interpolated image, a step of performing search using the third coarse search block to obtain a third optimal point with the highest degree of similarity to the third coarse search block in the macroblock. The step (c) comprises: (c-1) in the second interpolated image, a step of performing search of a surrounding region of the first optimal point using the first coarse search block to obtain an optimal motion vector with regard to the first coarse search block; (c-2) in the second interpolated image, a step of performing search of a surrounding region of the second optimal point using the second coarse search block; (c-3) in the second interpolated image, a step of performing search of a surrounding region of the third optimal point using the third coarse search block; and (c-4) in the second interpolated image, a step of performing search of the surrounding region of the first optimal point using each of the second coarse search block and said third coarse search block, the step (c-4) being carried out simultaneously with the step (c-1). In the step (c-1), the degree of similarity with respect to the first coarse search block at each point in the surrounding region of the first optimal point is calculated as a total sum of respective degrees of similarity that are obtained in the step (c-4) with respect to the second coarse search block and the third coarse search block.

A motion estimation method of a third invention is characterized in that, especially in the motion estimation method of the second invention, the execution of the step (c-2) is omitted when the first optimal point and the second optimal point coincide with each other.

Effect of the Invention

According to the motion estimation method of the first invention, with regard to the fine search blocks, only the surrounding region of the optimal point obtained in step (b) is searched. This eliminates the search targeting the entire region of the second interpolated image by using each one of the several fine search blocks. Thus the amount of calculation required for motion estimation can be reduced.

Further, in step (a), the several fine search blocks are so defined that the several fine search blocks are contained in the coarse search block. Thus the degree of similarity with respect to the coarse search block is calculated as a total sum of respective degrees of similarity that are obtained with respect to the several fine search blocks. As a result, the degree of similarity with respect to the coarse search block is not required to be obtained independently, so the amount of calculation required for motion estimation can be reduced to a greater degree.

According to the motion estimation method of the second invention, in step (c-4), the surrounding region of the first optimal point is searched using the second coarse search block and the third coarse search block. This widens the scopes of search with regard to the second coarse search block and the third coarse search block.

Further, the second coarse search block and the third coarse search block are so defined that the second and the third coarse search blocks are contained in the first coarse search block. Thus the degree of similarity with respect to the first coarse search block is calculated as a total sum of respective degrees of similarity that are obtained with respect to the second coarse search block and the third coarse search block. As a result, the degree of similarity with respect to the first coarse search block is not required to be obtained independently, so the amount of calculation required for motion estimation can be reduced.

According to the motion estimation method of the third invention, the execution of search of the surrounding region of the second optimal point is omitted when the first optimal point and the second optimal point coincide with each other. Thus the amount of calculation required for motion estimation can be reduced to a greater degree.

These and other objects, features, aspects and advantages will become more apparent from the following detailed description of the present invention when taken in conjunction with the accompanying drawings.

### BRIEF DESCRIPTION OF DRAWINGS

FIG. 1 is a flow chart showing the flow of a process in a motion estimation method according to an embodiment of the present invention;

FIG. 2 shows seven types of search blocks that can be used in H. 264;

FIG. 3 shows exemplary definition of a coarse search block and a fine search block;

FIG. 4 shows exemplary definition of a coarse search block and a fine search block;

FIG. 5 shows exemplary definition of a coarse search block and a fine search block;

FIG. 6 shows exemplary definition of a sparsely interpolated image and a densely interpolated image;

FIG. 7 shows exemplary definition of a sparsely interpolated image and a densely interpolated image; and

FIG. 8 shows exemplary definition of a sparsely interpolated image and a densely interpolated image.

### BEST MODE FOR CARRYING OUT THE INVENTION

An embodiment of the present invention is discussed below that is applied to H. 264 as one of high efficiency coding systems. The application of the present invention is not limited to H. 264. The present invention is applicable to all coding systems that allow motion compensation using several kinds of search blocks of different block sizes and several kinds of interpolated images of different pixel accuracies.

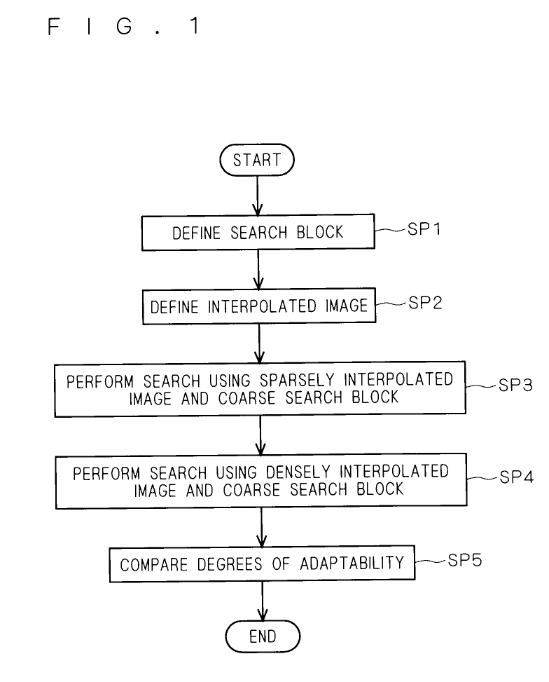

FIG. 1 is a flow chart showing the flow of a process in a motion estimation method according to the embodiment of the present invention.

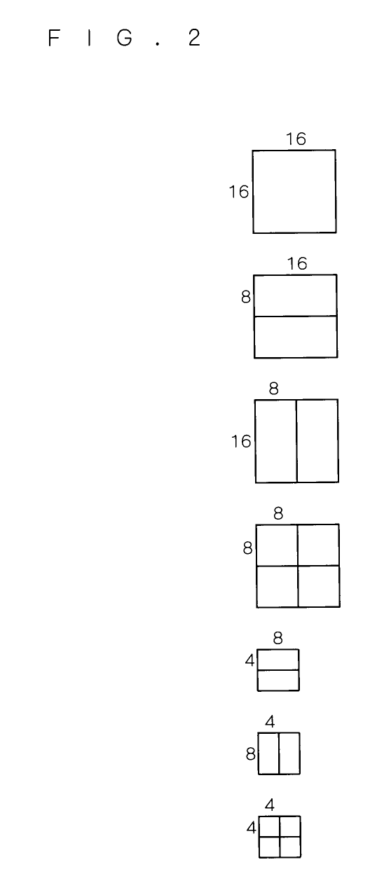

First, search blocks are defined in step SP1. As shown in FIG. 2, in H. 264, seven search blocks of different blocks sizes can be defined in a macroblock targeted for motion estimation (16 pixels in the horizontal direction by 16 pixels in the vertical direction, 16 pixels in the horizontal direction by 8 pixels in the vertical direction, 8 pixels in the horizontal direction by 16 pixels in the vertical direction, 8 pixels in the horizontal direction by 8 pixels in the vertical direction, 8 pixels in the horizontal direction by 4 pixels in the vertical direction, 4 pixels in the horizontal direction by 8 pixels in the vertical direction, and 4 pixels in the horizontal direction by 4 pixels in the vertical direction). In the motion estimation method according to the present embodiment, an arbitrary search block is selected from these search blocks to define a coarse search block and a fine search block.

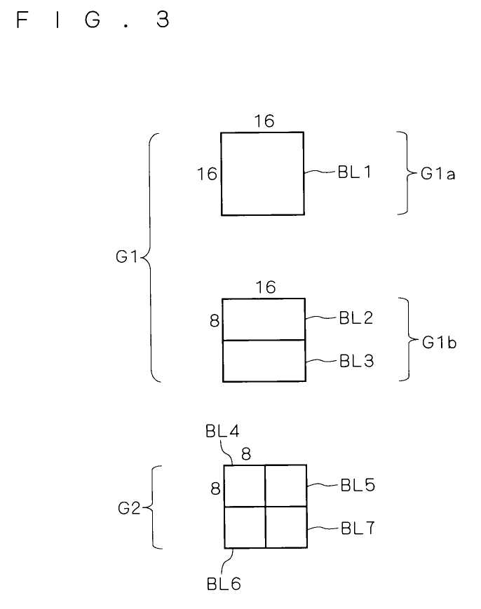

As shown for example in FIG. 3, a coarse search block G1 is defined by a search block BL1 with 16 pixels in the horizontal direction by 16 pixels in the vertical direction, and search blocks BL2 and BL3 with 16 pixels in the horizontal direction by 8 pixels in the vertical direction. A fine search block G2 is defined by search blocks BL4 to BL7 with 8 pixels in the horizontal direction by 8 pixels in the vertical direction. Here, fine search blocks are defined as search blocks given by dividing a coarse search block into a plurality of blocks so that the fine search blocks are contained in the coarse search block. Namely, with reference to FIG. 3, the fine search blocks BL4 to BL7 are contained in the coarse search block BL1. The fine search blocks BL4 and BL5 are contained in the coarse search block BL2. The fine search blocks BL6 and BL7 are contained in the coarse search block BL3.

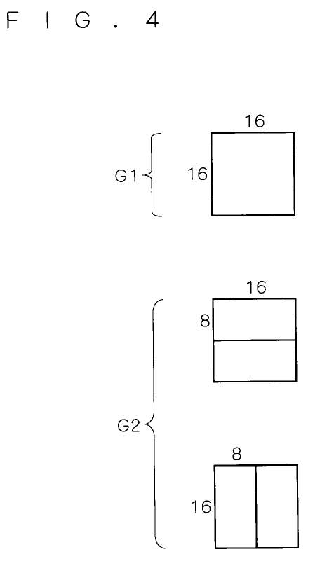

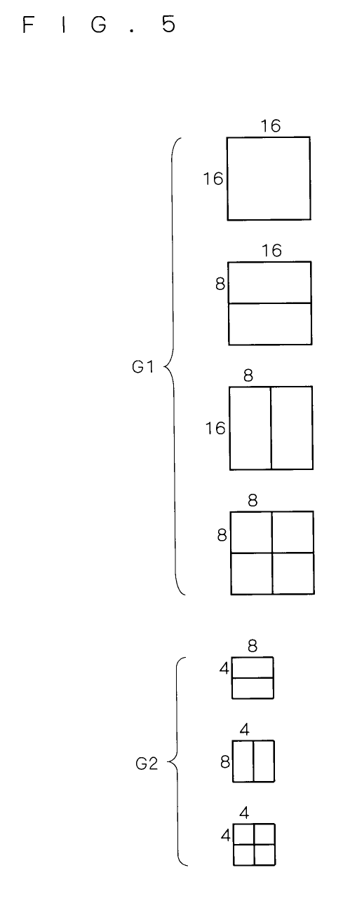

In place of FIG. 3, the coarse search block G1 and the fine search block G2 may be defined in alternative ways as shown for example in FIGS. 4 and 5. In each of FIGS. 4 and 5, the fine search block G2 is defined as search blocks given by dividing the coarse search block G1 into a plurality of blocks so that the fine search block G2 is contained in the coarse search block G1.

The present embodiment is discussed below when the coarse search block G1 and the fine search block G2 as shown in FIG. 3 are defined by way of illustration.

Next, interpolated images are defined in step SP2 shown in FIG. 1. In H. 264, three types of interpolated images of different pixel accuracies (integer pixel accuracy, half-pixel accuracy and quarter pixel accuracy) can be used. In the motion estimation method according to the present embodiment, an arbitrary interpolated image is selected from these interpolated images to define a sparsely interpolated image and a densely interpolated image.

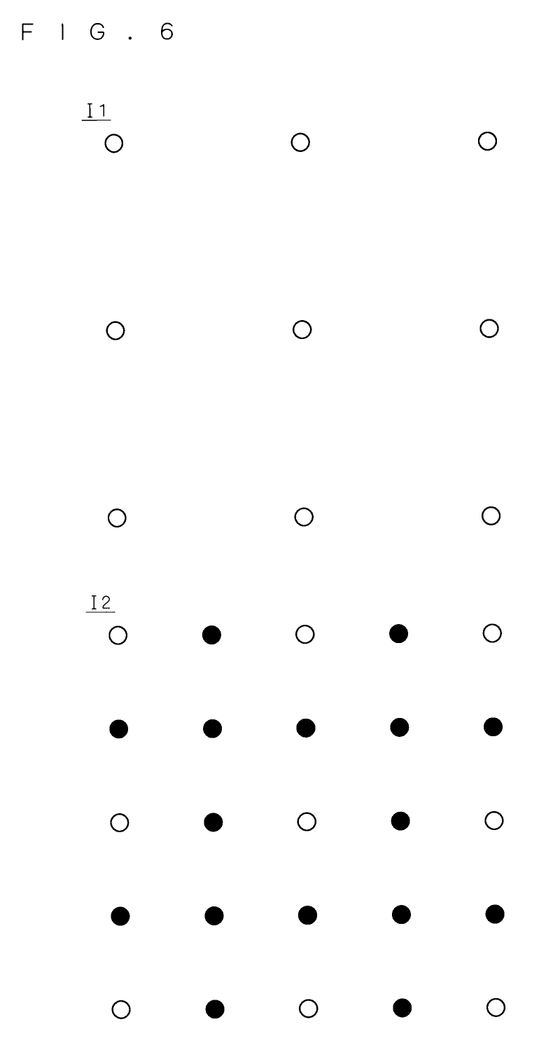

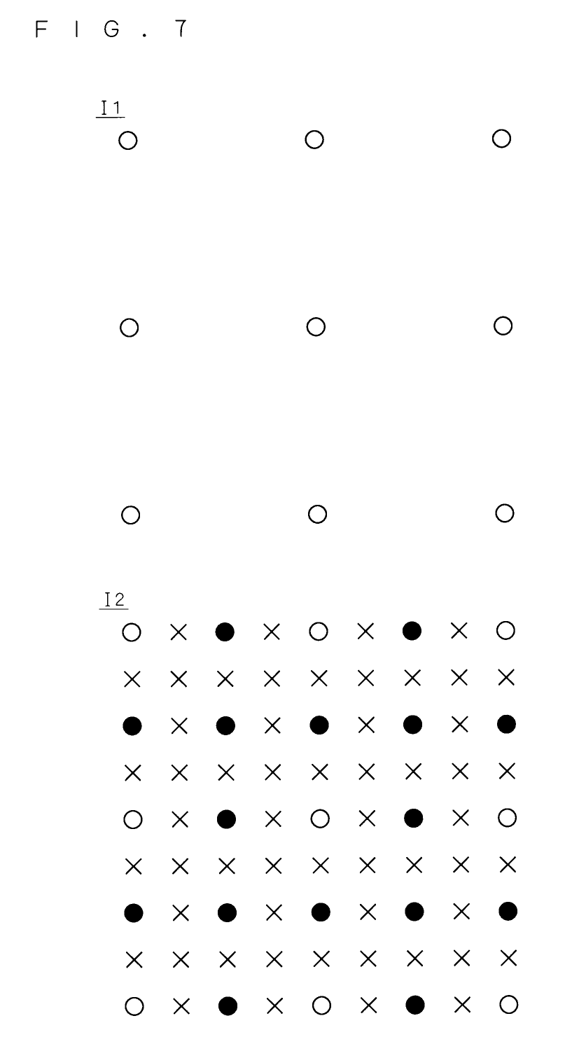

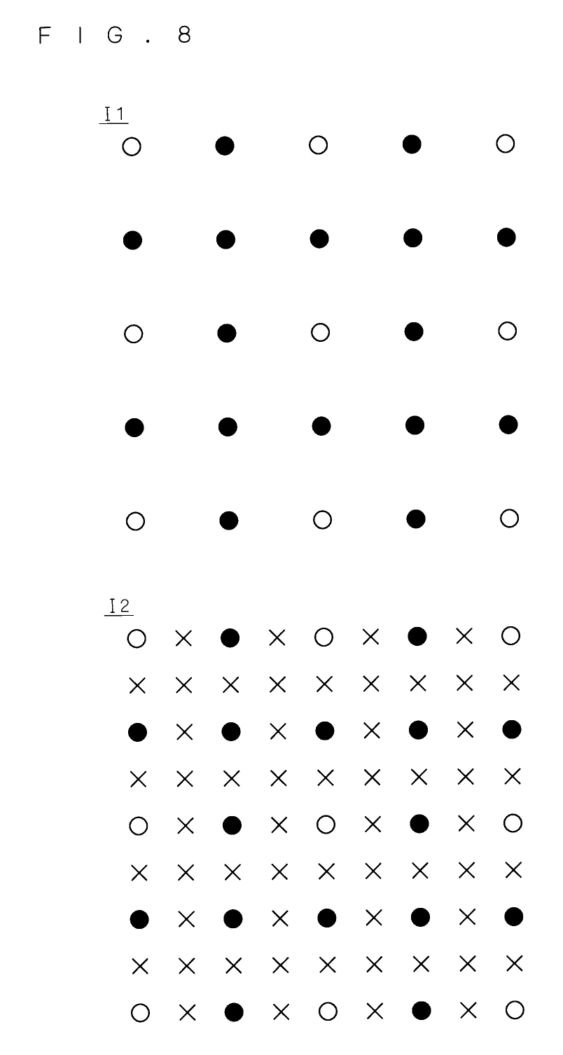

As shown for example in FIG. 6, an interpolated image of integer pixel accuracy is defined as a sparsely interpolated image I1, and an interpolated image of half-pixel accuracy is defined as a densely interpolated image I2. Alternatively, as shown in FIG. 7, an interpolated image of integer pixel accuracy is defined as a sparsely interpolated image I1, and an interpolated image of quarter-pixel accuracy is defined as a densely interpolated image I2, as shown in FIG. 7. Still alternatively, as shown in FIG. 8, an interpolated image of half-pixel accuracy is defined as a sparsely interpolated image I1, and an interpolated image of quarter-pixel accuracy is defined as a densely interpolated image I2.

Next, in step SP3 shown in FIG. 1, search is performed using the coarse search block G1 defined in step SP1 and the sparsely interpolated image I1 defined in step SP2. More specifically, search processes using the search blocks BL1 to BL3 shown in FIG. 3 are sequentially performed in the sparsely interpolated image I1. These search processes may be performed in any way. As an example, by using a search algorithm such as a gradient method, the sparsely interpolated image I1 is searched with respect to the search block BL1. Then, with regard to each point in the sparsely interpolated image I1 that has been subjected to the search, similarity to the search block BL1 in the macroblock is obtained (such as an SAD (sum of absolute differences). Similarity may be obtained using an index other than an SAD, or by incorporating an additional term. This is applicable to the following description.) The point at which an SAD scores lowest is defined as an optimal point with regard to the search block BL1 (hereinafter referred to as an “optimal point P1”). Likewise, an optimal point with regard to the search block BL2 (hereinafter referred to as an “optimal point P2”) is obtained, and an optimal point with regard to the search block BL3 (hereinafter referred to as an “optimal point P3”) is obtained.

Next, in step SP4 shown in FIG. 1, search is performed using the coarse search block G1 defined in step SP1 and the densely interpolated image I2 defined in step SP2. Unlike the search in step SP3, in the search performed in step SP4, the entire region of the interpolated image is not targeted for the search. Instead, only regions surrounding the optimal points obtained in step SP3 are subjected to the search.

With regard to the search block BL1, for example, only a surrounding region of the optimal point P1 (about plus or minus some pixels in both the horizontal direction and the vertical direction) in the densely interpolated image I2 is subjected to the search using the search block BL1. More specifically, the SAD between each point in the surrounding region of the optimal point P1 and the search block BL1 in the macroblock (hereinafter referred to as an “SAD1”) is obtained. Then, a motion vector representing a point at which the SAD1 scores lowest is defined as an optimal motion vector with regard to the search block BL1 (hereinafter referred to as an “optimal motion vector MV1”).

Here, in order to obtain the SAD1, the SADs between each point in the surrounding region of the optimal point P1 and the search blocks BL4 to BL7 that constitute the search block BL1 (hereinafter referred to as “SAD4” to “SAD7”) are respectively obtained. Then, the value of the SAD1 is calculated as a total sum of the values of the SAD4 to SAD7. Namely, the formula “SAD1=SAD4+SAD5+SAD6+SAD7” is established.

Likewise, with regard to the search block BL2, a surrounding region of the optimal point P2 in the densely interpolated image I2 is subjected to the search using the search block BL2. More specifically, the SAD between each point in the surrounding region of the optimal point P2 and the search block BL2 in the macroblock (hereinafter referred to as an “SAD2”) is obtained. Then, a motion vector representing a point at which the SAD2 scores lowest is defined as an optimal motion vector with regard to the search block BL2 (hereinafter referred to as an “optimal motion vector MV2”).

Here, in order to obtain the SAD2, the SAD4 and the SAD5 between each point in the surrounding region of the optimal point P2 and the search blocks BL4 and BL5 that constitute the search block BL2 are respectively obtained. Then, the value of the SAD2 is calculated as a total sum of the values of the SAD4 and the SAD5. Namely, the formula “SAD2=SAD4+SAD5” is established.

Likewise, with regard to the search block BL3, a surrounding region of the optimal point P3 in the densely interpolated image I2 is subjected to the search using the search block BL3. More specifically, the SAD between each point in the surrounding region of the optimal point P3 and the search block BL3 in the macroblock (hereinafter referred to as an “SAD3”) is obtained. Then, a motion vector representing a point at which the SAD3 scores lowest is defined as an optimal motion vector with regard to the search block BL3 (hereinafter referred to as an “optimal motion vector MV3”).

Here, in order to obtain the SAD3, the SAD6 and the SAD7 between each point in the surrounding region of the optimal point P3 and the search blocks BL6 and BL7 that constitute the search block BL3 are respectively obtained. Then, the value of the SAD3 is calculated as a total sum of the values of the SAD6 and the SAD7. Namely, the formula “SAD3=SAD6+SAD7” is established.

Several SADs4 are required to define the optimal motion vectors MV1 and MV2. A motion vector representing a point that is given the lowest value of these several SADs4 is defined as an optimal motion vector with regard to the search block BL4 (hereinafter referred to as an “optimal motion vector MV4”). This is also applicable to an optimal motion vector with regard to the search block BL5 (hereinafter referred to as an “optimal motion vector MV5”).

Several SADs6 are required to define the optimal motion vectors MV1 and MV3. A motion vector representing a point given the lowest value of these several SADs6 is defined as an optimal motion vector with regard to the search block BL6 (hereinafter referred to as an “optimal motion vector MV6”). This is also applicable to an optimal motion vector with regard to the search block BL7 (hereinafter referred to as an “optimal motion vector MV7”).

In the example shown in FIG. 3, the coarse search block GI is defined by the search block BL1, and by the search blocks BL2 and BL3. The search blocks BL2 and BL3 are contained in the search block BL1, so the coarse search block G1 may be divided into a first coarse search block G1a to which the search block BL1 belongs, and a second coarse search block G1b to which the search blocks BL2 and BL3 belong.

Thus, like the above-mentioned algorithm in which the search of the fine search block G2 is performed along with the search of the coarse search block G1, the search of the second coarse search block G1b may be performed along with the search of the first coarse search block G1a. More specifically, when the surrounding region of the optimal point P1 is searched using the search block BL1 in step SP4, the search using the search blocks BL2 and BL3 may be performed simultaneously. That is, the SAD2 with respect to the search block BL2 is obtained by SAD4+SAD5. The SAD3 with respect to the search block BL3 is obtained by SAD6+SAD7. The SAD1 with respect to the search block BL1 is obtained by SAD2+SAD3=SAD4+SAD5+SAD6+SAD7. Thus, the search using the search blocks BL2 and BL3 can be performed simultaneously with the search using the search block BL1.

In this case, based on the search result with regard to the surrounding region of the optimal point P2 and the search result with regard to the surrounding region of the optimal point P1, the optimal motion vector MV2 with regard to the search block BL2 is obtained as a motion vector representing a point at which the SAD2 scores lowest. Likewise, based on the search result with regard to the surrounding region of the optimal point P3 and the search result with regard to the surrounding region of the optimal point P1, the optimal motion vector MV3 with regard to the search block BL3 is obtained as a motion vector representing a point at which the SAD3 scores lowest. This widens the scopes of search with regard to the search blocks BL2 and BL3, so the motion vectors MV2 and MV3 can be obtained more accurately.

When the optimal point P1 and the optimal point P2 obtained in step SP3 coincide with each other, for example, the search using the search block BL2 is not required in step SP4. This is because, as the optimal point P1 and the optimal point P2 coincide with each other, the search using the search block BL2 can be performed simultaneously with the search using the search block BL1. The elimination of the search using the search block BL2 results in reduction of the amount of calculation required for motion estimation.

Next, in step SP5 shown in FIG. 1, degrees of adaptability of motion vectors per way of block division are compared to select a way of block division that provides the highest degree of adaptability. That is, with regard to each point in the densely interpolated image I2, the values of the SAD1, SAD2+SAD3, and SAD4+SAD5+SAD6+SAD7 are compared. Then, the way of division that provides the lowest value of the SAD is selected as an optimal way of block division with regard to the point. Based on this result, a motion vector of the macroblock targeted for motion estimation is obtained.

According to the motion estimation method of the present embodiment, with regard to the search blocks BL4 to BL7 belonging to the fine search block G2, the surrounding regions of the optimal points P1 to P3 obtained in step SP3 are searched. This eliminates the search targeting the entire region of the densely interpolated image I2 by using each one of the search blocks BL4 to BL7. Thus the amount of calculation required for motion estimation can be reduced.

Further, in step SP1, several fine search blocks G2 are defined so that the fine search blocks G2 are contained in the coarse search block G1. Thus, the SAD with respect to the coarse search block G1 is calculated as a total sum of the respective SADs with respect to the several fine search blocks G2. As a result, the SAD with respect to the coarse search block G1 is not required to be obtained independently, so the amount of calculation required for motion estimation can be reduced to a greater degree.

In the motion estimation method of the present embodiment, the motion estimation with regard to the fine search block G2 is simplified as compared to the full search method. It has been shown by a simulation conducted by the inventors that the degree of image degradation is considerably lower as compared to the full search method.

While the invention has been shown and described in detail, the foregoing description is in all aspects illustrative and not restrictive. It is therefore understood that numerous modifications and variations can be devised without departing from the scope of the invention.

1. A motion estimation method, comprising:
(a) in a macroblock targeted for motion estimation, a step of defining a coarse search block, and several fine search blocks that are given by dividing said coarse search block into a plurality of blocks so that said several fine search blocks are contained in said coarse search block;
(b) in a first interpolated image, a step of performing search using said coarse search block to obtain an optimal point with the highest degree of similarity to said coarse search block in said macroblock;
(c) in a second interpolated image denser than said first interpolated image, a step of performing search of a surrounding region of said optimal point using said coarse search block to obtain an optimal motion vector with regard to said coarse search block; and
(d) in said second interpolated image, a step of performing search of said surrounding region of said optimal point using each one of said several fine search blocks to obtain respective optimal motion vectors with regard to said fine search blocks, said step (d) being carried out simultaneously with said step (c),
in said step (c), the degree of similarity with respect to said coarse search block at each point in said surrounding region of said optimal point being calculated as a total sum of respective degrees of similarity that are obtained in said step (d) with respect to said several fine search blocks.

2. The motion estimation method according to claim 1, wherein said coarse search block includes a first coarse search block, and a second coarse search block and a third coarse search block that is given by dividing said first coarse search block into a plurality of blocks so that said second and said third coarse search blocks are contained in said first coarse search block,
said step (b) comprising:
(b-1) in said first interpolated image, a step of performing search using said first coarse search block to obtain a first optimal point with the highest degree of similarity to said first coarse search block in said macroblock;
(b-2) in said first interpolated image, a step of performing search using said second coarse search block to obtain a second optimal point with the highest degree of similarity to said second coarse search block in said macroblock; and
(b-3) in said first interpolated image, a step of performing search using said third coarse search block to obtain a third optimal point with the highest degree of similarity to said third coarse search block in said macroblock,
said step (c) comprising:
(c-1) in said second interpolated image, a step of performing search of a surrounding region of said first optimal point using said first coarse search block to obtain an optimal motion vector with regard to said first coarse search block;
(c-2) in said second interpolated image, a step of performing search of a surrounding region of said second optimal point using said second coarse search block;
(c-3) in said second interpolated image, a step of performing search of a surrounding region of said third optimal point using said third coarse search block; and
(c-4) in said second interpolated image, a step of performing search of said surrounding region of said first optimal point using each of said second coarse search block and said third coarse search block, said step (c-4) being carried out simultaneously with said step (c-1),
in said step (c-1), the degree of similarity with respect to said first coarse search block at each point in said surrounding region of said first optimal point being calculated as a total sum of respective degrees of similarity that are obtained in said step (c-4) with respect to said second coarse search block and said third coarse search block.

3. The motion estimation method according to claim 2, wherein the execution of said step (c-2) is omitted when said first optimal point and said second optimal point coincide with each other.
